(19) United States
(12) Patent Application Publication
(10) Pub. No.: US 2011/0057930 A1
(43) Pub. Date: Mar. 10, 2011

(54) SYSTEM AND METHOD OF USING HIGH-SPEED, HIGH-RESOLUTION DEPTH EXTRACTION TO PROVIDE THREE-DIMENSIONAL IMAGERY FOR ENDOSCOPY

(75) Inventors: Kurtis P. Keller, Hillsborough, NC (US); Sharif A. Razzaque, Chapel Hill, NC (US); Andrei State, Chapel Hill, NC (US); Caroline K. Green, Chapel Hill, NC (US)

(73) Assignee: INNEROPTIC TECHNOLOGY INC., Hillsborough, NC (US)

(21) Appl. No.: 12/943,795

(22) Filed: Nov. 10, 2010

Related U.S. Application Data
(63) Continuation of application No. 11/828,826, filed on Jul. 26, 2007.
(60) Provisional application No. 60/841,955, filed on Sep. 1, 2006.
(60) Provisional application No. 60/833,320, filed on Jul. 26, 2006.

(51) Int. Cl. G06T 15/00

(52) U.S. Cl. 345/419

(57) ABSTRACT

A system and method for providing high-speed, high-resolution three-dimensional imagery for endoscopy, particularly of a tissue surface at a medical procedure site is disclosed. High-resolution imagery provides greater detail of the tissue surface, but requires high-speed depth-frame imaging to provide timely updated depth information. A pattern of light, such as a point of light for example, may be projected onto the tissue surface and a reflected image analyzed to determine depth information. The point of light can be projected and analyzed quickly to produce faster depth-frame image rates. Three-dimensional structured-light depth resolution information may be generated and combined with either a two-dimensional image or a two-dimensional stereo image to provide three-dimensional imagery of the tissue surface. Switching between three-dimensional images and one of the two-dimensional image and a two-dimensional stereo image may also be provided. Further, the three-dimensional structured- light depth information may be further optimized by combining it with three-dimensional stereo-correspondence depth information to generate hybrid three-dimensional imagery.

### RELATED APPLICATIONS

This application is a continuation of and claims the benefit of U.S. patent application Ser. No. 11/828,826 entitled “System and Method of Using High-Speed, High-Resolution Depth Extraction to Provide Three-Dimensional Imagery for Endoscopy”, filed on Jul. 26, 2007, which in turn claims priority to U.S. Provisional Patent Application Ser. No. 60/833,320 entitled “High-Speed, High Resolution, 3-D Depth Extraction For Laparoscopy And Endoscopy,” filed Jul. 26, 2006, and U.S. Provisional Patent Application Ser. No. 60/841,955 entitled “Combined Stereo and Depth Reconstructive High-Definition Laparoscopy,” filed on Sep. 1, 2006, the disclosures of both of which are hereby incorporated herein by reference in their entireties.

### FIELD OF THE INVENTION

The present invention is directed to a system and method of using depth extraction techniques to provide high-speed, high-resolution three-dimensional imagery for endoscopic procedures. Further, the present invention is directed to a system and method of optimizing depth extraction techniques for endoscopic procedures.

### BACKGROUND OF THE INVENTION

It is well established that minimally-invasive surgery (MIS) techniques offer significant health benefits over their analogous laparotomic (or “open”) counterparts. Among these benefits are reduced trauma, rapid recovery time, and shortened hospital stays, resulting in greatly reduced care needs and costs. However, because of limited visibility of certain internal organs, some surgical procedures are at present difficult to perform minimally invasively. With conventional technology, a surgeon operates through small incisions using special instruments while viewing internal anatomy and the operating field through a two-dimensional video monitor. Operating below while seeing a separate image above can gives rise to a number of problems. These include the issue of parallax, a spatial coordination problem, and a lack of depth perception. Thus, the surgeon bears a higher cognitive load when employing MIS techniques than with conventional open surgery because the surgeon has to work with a less natural hand-instrument-image coordination.

One method that has been provided to address these problems is provided by a three-dimensional (3D) laparoscope disclosed in U.S. Pat. No. 6,503,195B1 entitled “METHODS AND SYSTEMS FOR REAL-TIME STRUCTURED LIGHT DEPTH EXTRACTION AND ENDOSCOPE USING REAL-TIME STRUCTURED LIGHT DEPTH EXTRACTION,” filed May 24, 1999 (hereinafter the “195 patent”) and U.S. Patent Application Publication No. 2005/0219552 A1 entitled “METHODS AND SYSTEMS FOR LASER BASED REAL-TIME STRUCTURED LIGHT DEPTH EXTRACTION,” filed Apr. 27, 2005 (hereinafter the “'552 application), both of which are incorporated herein by reference in their entireties. In the '195 patent and the '552 application, the surgeon can wear a video see-through head-mounted display and view a composite, dynamic three-dimensional image featuring a synthetic opening into the patient, akin to open surgery. This technology not only improves the performance of procedures currently approached minimally invasively, but also enables more procedures to be done via MIS. Consulting surgeons indicate a great need for such a device in a number of surgical specialties.

In 3D laparoscopy, the higher the resolution, the better the image quality for the surgeon. Depth information must also be updated in a timely manner along with captured scene information in order to provide the surgeon with a real-time image, including accurate depth information. However, depth scans require multiple video camera frames to be taken. A depth extraction technology must be employed that can produce the minimum or required number of depth frames in a given time (i.e., the rate) for the resolution of the surgical display. For example, the 3D laparoscope in the '195 patent and the '552 application uses a structured-light technique to measure the depth of points in the scene. For each depth frame, at least five (and often 32 or more) video camera frames (e.g., at 640×480 pixel resolution) are disclosed as being used to compute each single depth-frame (i.e., a single frame of 3D video).

Higher resolution images, including high definition (HD) resolution (e.g., 1024×748 pixels, or greater) may be desired for 3D laparoscopy technology to provide a higher resolution image than 640×480 pixel resolution, for example. However, even when using higher resolution video camera technology, which may for example capture 200 video frames per second, a 3D laparoscope may only generate 10-20 depth-frames per second. Higher resolution cameras also have lower frame-rates and less light sensitivity, which compound the speed problem described above. Thus, brighter structured-light patterns would have to be projected onto the tissue to obtain depth information, which provides other technical obstacles. Thus, there is a need to provide a higher resolution image for 3D laparoscopy, and any endoscopic procedure, by employing a system and method of providing a higher depth-frame rate in order to provide depth information for a higher resolution image in a timely fashion.

Furthermore, there may be a need for further optimizing depth extraction techniques. For example, structured-light techniques work well in resolving 3D depth characteristics for scenes with few surface features. However, stereo-correspondence techniques work well for scenes that are rich in sharp features and textures, which can be matched across the stereo image pair. Thus, there may be a further need to provide depth extraction techniques for an endoscope which provides three-dimensional depth characteristics for scenes having both sharp and few surface features.

### SUMMARY OF THE INVENTION

In general, the present invention is directed to a system and method of using depth extraction techniques to provide high-speed, high-resolution three-dimensional imagery for endoscopic procedures. Further, the present invention includes a system and method of optimizing the high-speed, high-resolution depth extraction techniques for endoscopic procedures

Three-dimensional high-speed, high-resolution imagery of a surface, including, but not limited to a tissue surface at a medical procedure site, may be accomplished using high-speed, high-resolution depth extraction techniques to generate three-dimensional high-speed, high-resolution image signals. Because the point of light illuminates only a single point on the tissue surface at any time, data may be captured by a sensor other than a two-dimensional array imager, and thus at a very high rate. In one embodiment, the structured-light technique may be used with a point of light from a projector, such as a laser for example. The use of the point of light results in a high-speed, high-resolution three-dimensional image of the tissue surface. Because the point of light illuminates only a single point on the tissue surface at any time, data may be captured by a sensor other than a two-dimensional array imager, and thus at a very high rate.

The point of light may be projected onto the tissue surface at a medical procedure site either through or in association with an endoscope. The projection of the point of light onto the tissue surface results in a reflected image of the tissue surface, which may be captured through or in association with the endoscope. The reflected image may include a region of brightness, which may be detected using a sensor other than a two-dimensional array imager. Such a sensor may be a continuous response position sensor, such as a lateral effect photodiode (LEPD) for example. Depth characteristics of the tissue surface may be determined based on information representative of the position of the region of brightness. From the depth characteristics, a three-dimensional structured-light depth map of the tissue surface may be generated. A three-dimensional image signal of the tissue surface may be generated from the three-dimensional structured-light depth map. The three-dimensional image signal may then be sent to a display for viewing the three-dimensional image of the tissue surface during the medical procedure.

In another embodiment, a three-dimensional image signal of the scene may be generated by a two-dimensional image signal of the tissue surface wrapped onto on the three-dimensional structured-light depth map. In this embodiment, the two-dimensional image of the tissue surface may be captured through the endoscope by a separate first two-dimensional imager. The first two-dimensional imager may be either monochromatic or color. If the first two-dimensional imager is monochromatic, the resultant three-dimensional image may include gray-scale texture when viewed on the display. If the two-dimensional imager is color, the resultant three-dimensional image may include color texture when viewed on the display.

In another embodiment, a two-dimensional stereo image of the tissue surface may be generated to allow for an alternative view of the three-dimensional image of the tissue surface. In this embodiment, a second two-dimensional imager is provided to generate two separate two-dimensional image signals. The two separate two-dimensional image signals are merged to generate a two-dimensional stereo image signal of the tissue surface. In this manner, the two-dimensional image signal, the two-dimensional stereo image signal, and the three-dimensional image signal may, alternately, be sent to a display. Switching may be provided to allow viewing of the tissue surface on the display between either the three-dimensional image signal and the two-dimensional image signal, or the three-dimensional image signal and the two-dimensional stereo image signal.

The present invention also includes exemplary embodiments directed to generating three-dimensional high-speed, high-resolution image signals using a three-dimensional structured-light technique in combination with a two-dimensional stereo-correspondence technique. The use of structured light may allow the effective resolution of depth characteristics for scenes having few surface features in particular. Stereo-correspondence may allow the effective resolution of depth characteristics for scenes having greater texture, features, and/or curvatures at the surface. Thus, the combined use of a structured-light technique in combination with a stereo-correspondence technique may provide an improved extraction of a depth map of a scene surface having both regions with the presence of texture, features, and/or curvature of the surface, and regions lacking texture, features, and/or curvature of the surface.

The two-dimensional image signals from the two separate two-dimensional imagers may be merged to generate a three-dimensional stereo-correspondence depth map. A three-dimensional stereo image signal of the tissue surface may be generated from the three-dimensional stereo-correspondence depth map. The three-dimensional stereo image signal may then be sent to the display for viewing during the medical procedure. In such a case, switching may be provided to allow viewing of the tissue surface on the display between either the three-dimensional image signal or the three-dimensional stereo image signal.

In another embodiment of the present invention, a hybrid three-dimensional image signal may be generated by using both the three-dimensional structured-light depth map and the three-dimensional stereo-correspondence depth map. The hybrid three-dimensional image signal may be generated by merging the three-dimensional stereo-correspondence depth map with the three-dimensional structured-light depth map. The hybrid three-dimensional image signal comprises the benefits of the three-dimensional structured-light image signal and the three-dimensional stereo image signal.

Those skilled in the art will appreciate the scope of the present invention and realize additional aspects thereof after reading the following detailed description of the preferred embodiments in association with the accompanying drawing figures.

### BRIEF DESCRIPTION OF THE DRAWINGS

The accompanying drawing figures incorporated in and forming a part of this specification illustrate several aspects of the invention, and together with the description serve to explain the principles of the invention.

FIG. 1 is a schematic diagram illustrating an exemplary imaging system wherein a high-speed, high-resolution three-dimensional image depth map of a tissue surface at a medical procedure site may be generated using a point of light projected onto the tissue surface, according to an embodiment of the present invention;

FIG. 2 is a flow chart illustrating a process for generating the three-dimensional image depth map signal of the tissue surface using a point of light depth resolution technique, which is a type of structured-light technique, according to an embodiment of the present invention;

FIG. 3 is a block diagram of a projector/scanner used to project the point of light onto the tissue surface according to an embodiment of the present invention;

FIGS. 4A, 4B, and 4C illustrate exemplary depth resolution sensors in the form of lateral effect photodiodes (LEPDs) which may be used to detect a position of a region of brightness of a reflected image of the tissue surface resulting from the point of light to obtain depth characteristics of the tissue surface to provide a three-dimensional depth map of the tissue surface, according to an embodiment of the present invention;

FIG. 5 is a schematic diagram illustrating an exemplary system for calibrating a depth resolution sensor according to an embodiment of the present invention;

FIG. 6 is a flow chart illustrating an exemplary process for calibrating the depth resolution sensor system illustrated in FIG. 5 according to an embodiment of the present invention;

FIG. 7 is a representation illustrating an exemplary depth characteristic look-up table to convert depth resolution sensor signals to depth characteristic information of the tissue surface according to an embodiment of the present invention;

FIG. 8 is a schematic diagram illustrating an alternative exemplary imaging system to FIG. 1, additionally including a two-dimensional imager to allow generation of a three-dimensional image signal of the tissue surface as a result of wrapping a two-dimensional image signal of the tissue surface onto the three-dimensional structured-light depth map of the tissue surface according to an embodiment of the present invention;

FIG. 9 is a flow chart illustrating an exemplary process for generating the three-dimensional image signal as a result of wrapping the two-dimensional image signal of the tissue surface onto the three-dimensional structured-light depth map of the tissue surface according to an embodiment of the present invention;

FIG. 10 is a schematic diagram illustrating an alternate exemplary system to those in FIGS. 1 and 8, additionally including a second two-dimensional imager to produce a two-dimensional stereo image signal of the tissue surface, and wherein switching is provided to allow viewing of the tissue surface on a display between either the three-dimensional image signal and the two-dimensional image signal, or the three-dimensional image signal and the two-dimensional stereo image signal according to an embodiment of the present invention;

FIG. 11 is a flow chart illustrating an exemplary process for merging the two separate two-dimensional image signals from two separate two-dimensional imagers to generate the two-dimensional stereo image signal according to an embodiment of the present invention;

FIG. 12 is a flow chart illustrating an exemplary process for allowing switching of an image displayed on the display between either the three-dimensional image signal and the two-dimensional image signal, or between the three-dimensional image signal and the two-dimensional stereo image signal according to an embodiment of the present invention;

FIG. 13 is an optical schematic diagram of FIG. 10, illustrating additional optical components and detail according to an embodiment of the present invention;

FIG. 14 is a flow chart illustrating an exemplary process for generating the three-dimensional structured-light depth map and a two-dimensional stereo image signal of the tissue surface by projecting the point of light and capturing a first two-dimensional image through a first channel of the endoscope, and capturing the reflected image and a second two-dimensional image through a second channel of the endoscope and filtering the point of light from the second two-dimensional image signal, and the reflected image from the first two-dimensional image, according to an embodiment of the present invention; and

FIG. 15 is a flow chart illustrating an exemplary process for merging a three-dimensional structured-light depth map with a two-dimensional stereo-correspondence depth map to generate a hybrid three-dimensional image signal according to an embodiment of the present invention.

FIG. 16 is a flow chart illustrating an exemplary process for allowing switching between the hybrid three-dimensional image signal and the three-dimensional image signal according to an embodiment of the present invention.

FIG. 17 illustrates a diagrammatic representation of a controller in the exemplary form of a computer system adapted to execute instructions from a computer-readable medium to perform the functions for using high-speed, high-resolution depth extraction to provide three-dimensional imagery according to an embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

In general, the present invention is directed to a system and method of using depth extraction techniques to provide high-speed, high-resolution three-dimensional imagery for endoscopic procedures. Further, the present invention includes a system and method of optimizing the high-speed, high-resolution depth extraction techniques for endoscopic procedures

Three-dimensional high-speed, high-resolution imagery of a surface, including, but not limited to a tissue surface at a medical procedure site, may be accomplished using high-speed, high-resolution depth extraction techniques to generate three-dimensional high-speed, high-resolution image signals. Because the point of light illuminates only a single point on the tissue surface at any time, data may be captured by a sensor other than a two-dimensional array imager, and thus at a very high rate. In one embodiment, the structured-light technique may be used with a point of light from a projector, such as a laser for example. The use of the point of light results in a high-speed, high-resolution three-dimensional image of the tissue surface. Because the point of light illuminates a single point on the tissue surface at any given time, data may be captured by a sensor at a very high rate.

The point of light may be projected onto the tissue surface at a medical procedure site either through or in association with an endoscope. The projection of the point of light onto the tissue surface results in a reflected image of the tissue surface, which may be captured through or in association with the endoscope. The reflected image may include a region of brightness, which may be detected using a sensor other than a two-dimensional array imager. Such a sensor may be a continuous response position sensor, such as a lateral effect photodiode (LEPD) for example. Depth characteristics of the tissue surface may be determined based on information representative of the position of the region of brightness. From the depth characteristics, a three-dimensional structured-light depth map of the tissue surface may be generated. A three-dimensional image signal of the tissue surface may be generated from the three-dimensional structured-light depth map. The three-dimensional image signal may then be sent to a display for viewing the three-dimensional image of the tissue surface during the medical procedure.

In another embodiment, a three-dimensional image signal of the scene may be generated by a two-dimensional image signal of the tissue surface wrapped onto on the three-dimensional structured-light depth map. In this embodiment, the two-dimensional image of the tissue surface may be captured through the endoscope by a separate first two-dimensional imager. The first two-dimensional imager may be either monochromatic or color. If the two-dimensional imager is monochromatic, the resultant three-dimensional image may include gray-scale texture when viewed on the display. If the first two-dimensional imager is color, the resultant three-dimensional image may include color texture when viewed on the display.

In another embodiment, a two-dimensional stereo image of the tissue surface may be generated to allow for an alternative view of the three-dimensional image of the tissue surface. In this embodiment, a second two-dimensional imager is provided to generate two separate two-dimensional image signals. The two separate two-dimensional image signals are merged to generate a two-dimensional stereo image signal of the tissue surface. In this manner, the two-dimensional image signal, the two-dimensional stereo image signal, and the three-dimensional image signal may, alternately, be sent to a display. Switching may be provided to allow viewing of the tissue surface on the display between either the three-dimensional image signal and the two-dimensional image signal, or the three-dimensional image signal and the two-dimensional stereo image signal.

The present invention also includes exemplary embodiments directed to generating three-dimensional high-speed, high-resolution image signals using a three-dimensional structured-light technique in combination with a two-dimensional stereo-correspondence technique. The use of structured light may allow the effective resolution of depth characteristics for scenes having few surface features in particular. Stereo-correspondence may allow the effective resolution of depth characteristics for scenes having greater texture, features, and/or curvatures at the surface. Thus, the combined use of a structured-light technique in combination with a stereo-correspondence technique may provide an improved extraction of a depth map of a scene surface having both regions with the presence of texture, features, and/or curvature of the surface, and regions lacking texture, features, and/or curvature of the surface.

The two-dimensional image signals from the two separate two-dimensional imagers may be merged to generate a three-dimensional stereo-correspondence depth map. A three-dimensional stereo image signal of the tissue surface may be generated from the three-dimensional stereo-correspondence depth map. The three-dimensional stereo image signal may then be sent to the display for viewing during the medical procedure. In such a case, switching may be provided to allow viewing of the tissue surface on the display between either the three-dimensional structured-light image signal or the three-dimensional stereo-correspondence image signal.

In another embodiment of the present invention, a hybrid three-dimensional image signal may be generated by using both the three-dimensional structured-light depth map and the two-dimensional stereo-correspondence depth map. The hybrid three-dimensional image signal may be generated by merging the three-dimensional stereo-correspondence depth map with the three-dimensional structured-light depth map. The hybrid three-dimensional image signal comprises the benefits of the three-dimensional structured-light image signal and the three-dimensional stereo-correspondence image signal.

Please note that although the present invention is described with reference to the tissue surface at the medical procedure site, it should be understood that the present invention applies to any type of surface, and accordingly, the present invention should not limited to tissue surfaces at the medical procedure site, but shall include, but not be limited to, bone, tools, prosthetics, and any other surface not at the medical procedure site. Further, although in discussing the embodiments of the present invention the term “signal” may be used with respect to an image, it should be understood that “signal” refers to any means, method, form, and/or format for sending and/or conveying the image and/or information representative of the image including, but not limited to, visible light, digital signals, and/or analog signals.

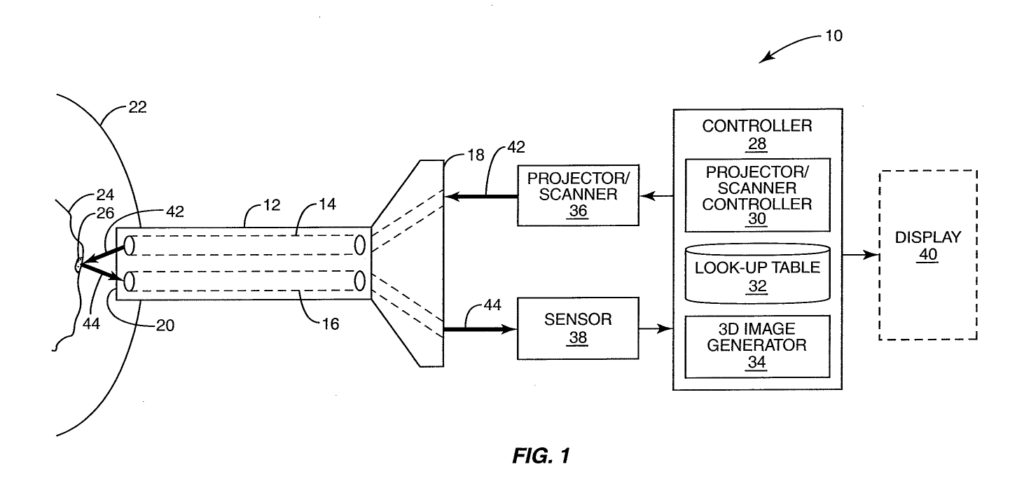

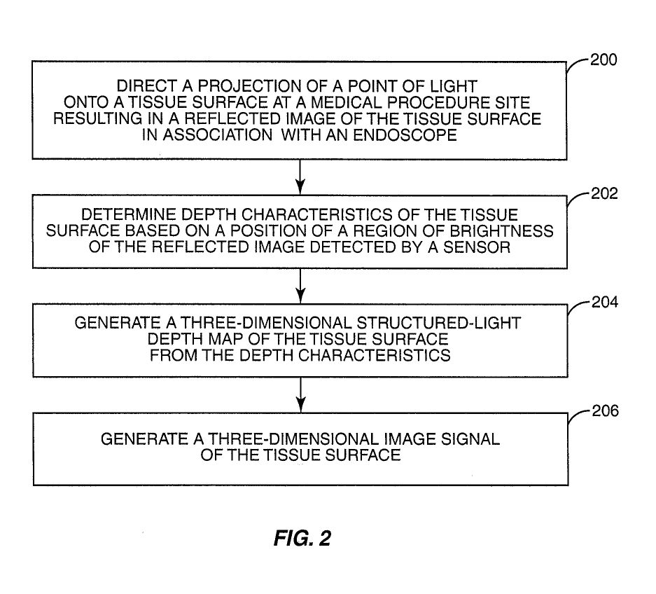

FIG. 1 illustrates a schematic diagram of an exemplary three-dimensional depth extraction system 10 for generating a three-dimensional image signal of a tissue surface using a high-speed, high-resolution structured-light technique according to one embodiment of the present invention. FIG. 2 is a flow chart illustrating a process for generating the three-dimensional image signal of the tissue surface using a point of light in the system 10 according to one embodiment of the present invention.

High-speed, high-resolution three-dimensional imagery provides a better image quality of the tissue surface and, therefore, improves visualization of the medical procedure site. For purposes of describing the present invention, high-speed may refer to a depth map generated at a rate of at least 10 depth maps per second. Similarly, high-resolution may refer to a depth map having at least 50×50 depth samples per map. The three-dimensional structured-light depth map may be generated by projecting a point of light onto the tissue surface and then detecting a position of brightness on a reflected image resulting from the projection of the point of light. Because a projected point of light is used to obtain depth resolution information regarding the tissue surface, higher speed depth scans can be obtained so that high-speed, high-resolution images of the tissue surface can be provided.

In this regard, the system 10 may comprise an endoscope 12 used in a medical procedure, such as minimally invasive surgery (MIS) for example. The endoscope 12 may be any standard dual-channel endoscope. The endoscope 12 may have a first channel 14, a second channel 16, a distal end 18, and a tip 20. The endoscope 12 may be inserted at a medical procedure site 22 into a patient in a manner to align the tip 20 generally with a tissue surface 24, and particularly to align the tip 20 in appropriate proximity with a point of interest 26 on the tissue surface 24. A controller 28 may be provided in the system 10. The controller 28 may comprise a projector/scanner controller 30, a look-up table 32, and a 3D image generator 34. The controller 28 may be communicably coupled to a projector/scanner 36, a sensor 38, and a display 40. The display 40 is not part of the present invention and, therefore, is shown in dashed outline in FIG. 1. The projector/scanner 36 may project a point of light 42 onto the point of interest 26. The point of light 42 projected on the point of interest 26 may result in a reflected image 44 of the, point of interest 26 of the tissue surface 24. The reflected image 44 may be captured by the sensor 38.

As illustrated in FIG. 2, the controller 28 directs the projection of the point of light 42 onto the tissue surface 24 at the medical procedure site 22 resulting in a reflected image 44 of the tissue surface 24 in association with the endoscope 12 (step 200). The projector/scanner controller 30 in the controller 28 may provide control and direction to the projector/scanner 36 of the projection of the point of light 42. The point of light 42 may be a single color laser light, which may be green for example. The point of light 42 may be about 0.4 millimeters (mm) in size and approximately circular.

The controller 28 determines depth characteristics of the tissue surface 24 based on a position of the region of brightness of the reflected image 44 detected by the sensor 38 (step 202). The controller 28 may use the 3D image generator 34 to determine the depth characteristics using a triangulation method based on the law of cosines. An example of the triangulation method is described in a National Research Council of Canada paper entitled “Optimized Position Sensors for Flying-Spot Active Triangulation Systems” published in Proceedings of the Fourth International Conference on 3-D Digital Imaging and Modeling (3DIM), Banff, Alberta Canada, Oct. 6-10, 2003. pp 334-341, NRC 47083, which is hereby incorporated by reference herein in its entirety.

The controller 28 generates a three-dimensional structured-light depth map of the tissue surface 24 from the depth characteristics (step 204). The controller 28 may use the 3D image generator 34 to generate the three-dimensional structured-light depth map. The three-dimensional structured-light depth map may be generated by directing the projector/scanner 36 to scan the point of light 42 such that the point of light 42 is projected on the points of interest 26 on the tissue surface 24 based on a specified x-y coordinate on the tissue surface 24. A reflected image 44 may result for each point of interest 26. The depth characteristics for each point of interest 26 may be determined from information representative of the position of the region of brightness on the reflected image 44 for each point of interest 26 and individually mapped to generate the three-dimensional structured-light depth map. The controller 28 then generates a three-dimensional image signal of the tissue surface 24 from the three-dimensional structured-light depth map (step 206).

The controller 28 may be any suitable device or group of devices capable of interfacing with and/or controlling the components of the system 10 and the functions, processes, and operation of the system 10 and the components of the system 10. The capabilities of the controller 28 may include, but are not limited to, sending, receiving, and processing analog and digital signals, including converting analog signals to digital signals and digital signals to analog signals; storing and retrieving data; and generally communicating with devices that may be internal and/or external to the system 10. Such communication may be either direct or through a private and/or public network, such as the Internet for example. As such, the controller 28 may comprise one or more computers, each with a control system, appropriate software and hardware, memory, storage unit, and communication interfaces.

The projector/scanner controller 30 may be any program, algorithm, or control mechanism that may direct and control the operation of the projector/scanner 36. The projector/scanner 36 may comprise any suitable device or devices, which may project a point of light 42 onto the tissue surface 24 and scan the point of light 42 over the tissue surface 24 in a manner to align the point of light 42 with the point of interest 26 on the tissue surface 24. The projector/scanner 36 may be located at the distal end 18 of the endoscope 12 and may be optically connected with the first channel 14 of the endoscope 12. Alternatively, although not shown in FIG. 1, the projector/scanner 36 may be located at the tip 20 of the endoscope 12.

In the case where the projector/scanner 36 is located at the distal end 18 of the endoscope 12 and optically connected to the first channel 14, the projector/scanner 36 may project the point of light 42 through the first channel 14 onto the tissue surface 24. In the case where the projector/scanner 36 is located at the tip 20, the projector/scanner 36 may project the point of light 42 directly onto the tissue surface 24 without projecting the point of light 42 through the first channel 14. In either case, the projector/scanner controller 30 may direct the projector/scanner 36 to scan the point of light 42 such that the point of light 42 is projected sequentially onto multiple points of interest 26 based on a specified x-y coordinate on the tissue surface 24.

The sensor 38 may be any device other than a two-dimensional array imager. For example, the sensor 38 may comprise an analog based, continuous response position sensor, such as a LEPD for example. The sensor 38 may be located at the distal end 18 as shown in FIG. 1, and may be optically connected with the second channel 16 of the endoscope 12. As with the projector/scanner 36, alternatively, the sensor 38 may be located at the tip 20. In the case where the sensor 38 is located at the distal end 18, the sensor 38 may capture the reflected image 44 through the second channel 16. The reflected image 44 may include a region of brightness, the position of which the sensor 38 may be capable of detecting. Information representative of the position of the region of brightness on the reflected image 44 may be communicated by the sensor 38 and received by the controller 28.

The look-up table 32 may be any suitable database for recording and storing distance values which may be used in determining depth characteristics of the tissue surface 24. The distance values relate to the distance from the tip 20 to the point of interest 26, and may be based on information representative of the position of the region of brightness on the reflected image 44.

The 3D image generator 34 may be any a program, algorithm, or control mechanism for generating a three-dimensional image signal representative of a three-dimensional image of the tissue surface 24. The 3D image generator 34 may be adapted to generate a three-dimensional structured-light depth map from the information representative of the area of brightness of the reflected image 44 and then from the three-dimensional structured-light depth map generate the three-dimensional image signal. The 3D image generator 34 may comprise one or more graphics cards, such as a Genesis graphics card available from Matrox Corporation. Alternatively, the controller 28 may comprise an Onyx Infinite Reality system available from Silicon Graphics, Inc. to provide a portion of the 3D image generator 34 functions.

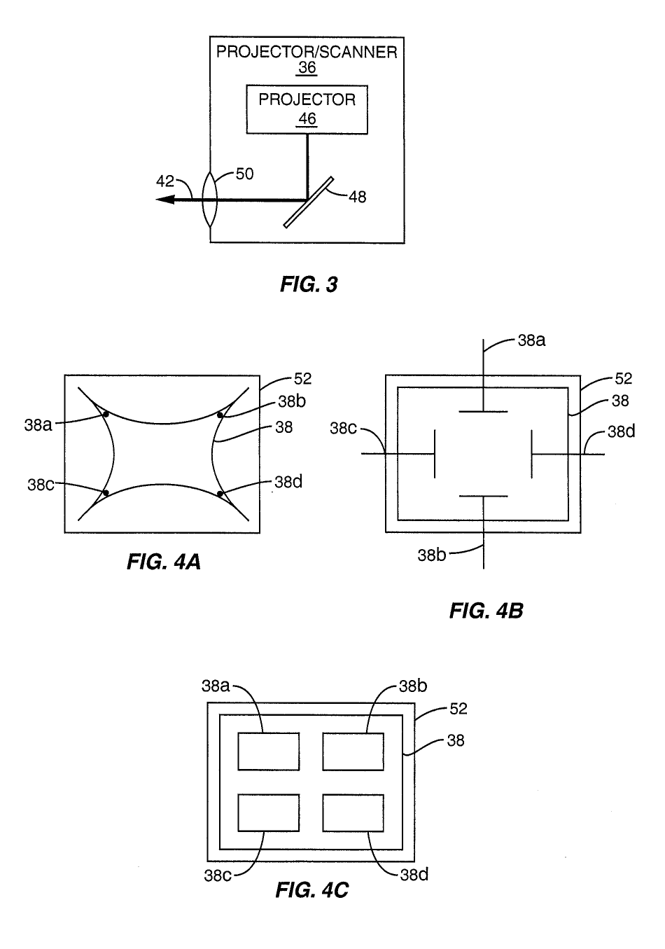

FIG. 3 is a block diagram illustrating detail of the projector/scanner 36 to describe its components and operation according to one embodiment of the present invention. FIG. 3 is provided to illustrate and discuss details of the components comprising the projector/scanner 36 and the manner in which they may be arranged and may interact. The projector/scanner 36 may comprise a projector 46 and a scanner 48. The projector 46 may be a solid-state laser capable of projecting a point of light 42 comprising a single color laser light. In the preferred embodiment, a green laser light with a wavelength of approximately 532 nanometers is used. The point of light 42 may be slightly larger than the point of interest 26, at approximately about 0.4 mm. Additionally, the projector 46 may project a point of light 42 with a slightly Gaussian beam such that the center of the beam is slightly brighter than the surrounding portion.

The scanner 48 may be any suitable device comprising, alternatively or in combination, one or more mirrors, lenses, flaps, or tiles for aiming the point of light 42 at the point of interest 26 in response to direction from the projector/scanner controller 30. The projector/scanner controller 30 may direct the scanner 48 to aim the point of light 42 onto multiple points of interest 26 based on predetermined x-y coordinates of each of the points of interest 26. If the scanner 48 comprises one mirror, the scanner 48 may tilt or deflect the mirror in both an x and y direction to aim the point of light 42 at the x-y coordinates of the point of interest 26. If the scanner 48 comprises multiple mirrors, one or more mirrors may aim the point of light 42 in the x direction and one or more mirrors may aim the point of light in the y direction.

The scanner 48 may comprise a single multi-faceted spinning mirror where each row (the x coordinates in one y coordinate line) may be a facet. Alternatively or additionally, the scanner 48 may comprise multiple multi-faceted mirrors on spinning disks where one multi-faceted mirror aims the point of light 42 for the x coordinates of the points of interest 26 and one multi-faceted mirror aims the point of light 42 for the y coordinates of the points of interest 26. The scanner 48 may also comprise flaps or tiles that move independently to steer the point of light 42 to aim at the x-y coordinates of the point of interest 26. Also, the scanner 48 may comprise one or more lenses to aim the point of light 42 in similar fashion to the mirrors, but using deflection in the transmission of the point of light 42 instead of reflection of the point of light 42.

Additionally, the scanner 48 may comprise software and hardware to perform certain ancillary functions. One such function may comprise a safety interlock with the projector 46. The safety interlock prevents the projector 46 from starting or, if the projector 46 is already operating, causes the projector 46 to turn off if the scanner 48 at any time is not operating and/or stops operating. The safety interlock may be provided such that it cannot be overridden, whether in software or hardware. Additionally, the safety interlock may be provided to default or fail to a safe condition. If the safety interlock cannot determine whether the scanner 48 is operating appropriately, or if the safety interlock fails, the safety interlock acts as if the scanner 48 has stopped operating and may prevent the projector 46 from starting, or may turn the projector 46 off if operating. In this manner, the projector 46, which as discussed above, may be a laser, is prevented from dwelling too long at the point of interest 26 to avoid possibly burning the tissue surface 24. Other ancillary functions, such as an informational light and/or an alarm, may be included to advise of the operating status of the scanner 48 and/or the projector 46.

The scanner 48 may also comprise a projection lens 50 located in the path of the projection of the point of light 42. The projection lens 50 may provide physical separation of the components of the projector/scanner 36 from other components of the system 10, and also may focus the projection of the point of light 42 as necessary or required for projection on the point of interest 26, including through the first channel 14 of the endoscope 12 if the projector/scanner 36 is located at the distal end 18. An exemplary scanner 48 is a scanner manufactured by Microvision Inc.

Once the scanner 48 aims the point of light 42 at the point of interest 26 and the point of light 42 is projected onto the point of interest 26, a reflected image 44 of the tissue surface 24 may result. The reflected image 44 may be detected by the sensor 38, either directly if the sensor 38 is located at the tip 20, or captured through the second channel 16 if the sensor 38 is located at the distal end 18. The sensor 38 may be an analog based, continuous response position sensor such as a LEPD for example. The LEPD is an x-y sensing photodiode which measures the intensity and position of a point of light that is focused on the LEPD's surface. There are various sizes and types of LEPDs which may be used in the present invention.

FIGS. 4A, 4B, and 4C illustrate three types of LEPDs that may be used in one embodiment of the present invention. LEPDs are a type of continuous response position sensors, which are analog devices that have a very fast response time, on the order of 10 megahertz (MHz). This high response time in combination with the point of light 42 projection allows for high-speed depth resolution resulting in high-speed, high-resolution three-dimensional imaging.

In the following discussion of FIGS. 4A, 4B, 4C, 5, and 6, the use of the term LEPD shall be understood to mean the sensor 38, and as such the terms LEPD and sensor shall be interchangeable. FIGS. 4A, 4B, and 4C provide details of the formats and connections of various LEPDs 38 to describe how the LEPD 38 detects the position of the region of brightness of the reflected image 44. The LEPDs 38 shown in FIGS. 4A, 4B, and 4C may be structured to provide four connections 38a, 38b, 38c, and 38d to allow for connecting to associated circuitry in the LEPD 38. The associated circuitry may be in the form of a printed circuit board 52 to which the LEPD 38 may be mounted and connected. FIGS. 4A and 4B illustrate two forms of LEPD 38 using a single diode pad, while FIG. 4C illustrates a form of LEPD 38 using four separate diode pads. Notwithstanding the form, the LEPD 38 detects the position of the region of brightness of the reflected image 44 in relation to a center area of the LEPD 38.

The LEPD 38 produces two output voltages based on the position of the region of brightness detected by the LEPD 38. Accordingly, one output voltage represents the horizontal position of the region of brightness of the reflected image 44, and one output voltage represents the vertical position of the region of brightness of the reflected image 44. As the projector/scanner 36 scans the point of light 42 onto different points of interest 26, the point of interest 26 on which the point of light 42 is currently projected may be at a different depth than the point of interest 26 on which the point of light 42 was previously projected. This may result in the position of the region of brightness of the reflected image 44 to be detected by the LEPD 38 at a different location. As such, the difference in the depth causes a difference in the location of the position of the region of brightness which may change the output voltage that represents the horizontal position of the region of brightness and the output voltage that represents the vertical position of the region of brightness.

By associating the differences in the output voltages with the position of the point of interest 26 using the standard triangulation method discussed above, a structured-light depth map may be generated. As the projector/scanner 36 scans the point of light 42 onto each point of interest 26 on the tissue surface 24, the depth value associated with a particular pair of output voltages resulting from the location of the region of brightness of the reflected image 44 detected by the LEPD 38 may be calculated. The depth values calculated may be mapped onto an x-y coordinate system associated with the tissue surface 24. In such a case, the depth values for an individual point of interest 26 may be separately calculated and mapped to the particular x-y coordinate associated with the point of interest 26.

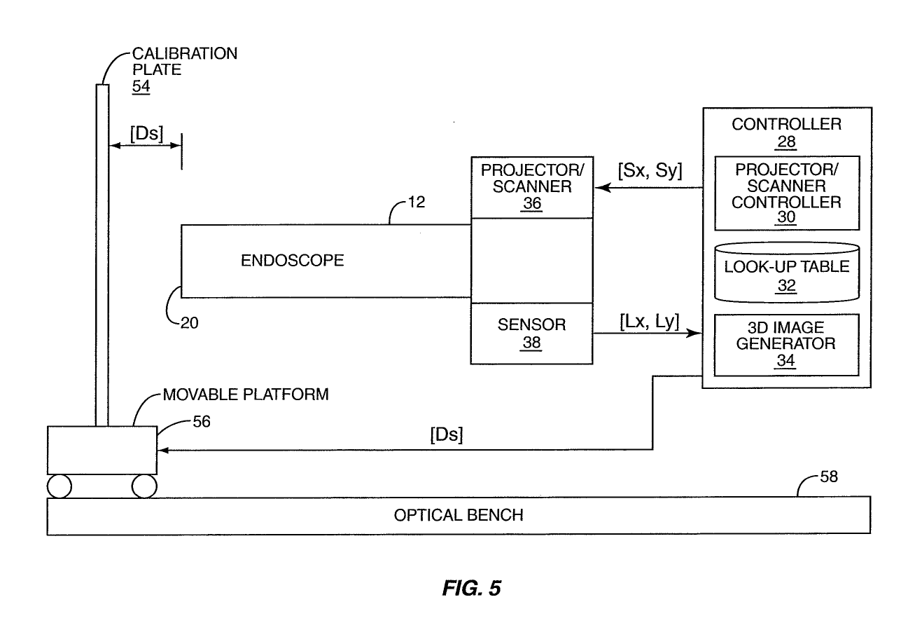

Instead of separately calculating the depth of each point of interest 26 on the tissue surface 24, a look-up table 32 of distance values may be produced. The look-up table 32 may be produced by calibrating the sensor 38 using a target surface and moving the target surface through a range of distance. FIG. 5 is a schematic diagram illustrating an exemplary system for calibrating the sensor 38 according to one embodiment of the present invention. FIG. 5 includes the controller 28, the projector/scanner 36, the sensor 38, and the endoscope 12 of the system 10. FIG. 5 also includes a calibration plate 54 mounted on a movable platform 56 on an optical bench 58.

The calibration plate 54 is perpendicular to the viewing axis of the endoscope 12, planar, and covered in a diffused white coating or paint. The controller 28 causes the movable platform 56 to move along the optical bench 58 at specified distances “Ds” measured between the calibration plate 54 and the tip 20 of the endoscope 12. At each distance “Ds,” the projector/scanner controller 30 directs the projector/scanner 36 to project the point of light 42 at a series of coordinates “Sx,” “Sy.” For each coordinate “Sx,” “Sy,” the sensor 38 detects the position of the region of brightness of a reflected image 44 and outputs the position as coordinates “Lx,” “Ly” to the controller 28. The distances “Ds,” scan coordinates “Sx,” Sy,” and position coordinates “Lx,” “Ly” are recorded in the look-up table 32. The sensor 38 is then calibrated to the values in the look-up table 32.

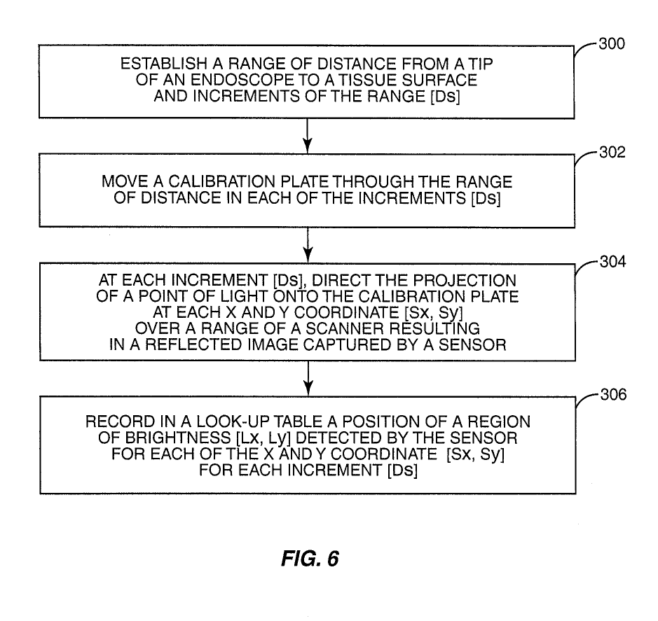

FIG. 6 is a flow chart further illustrating the process for calibrating the sensor 38 using the system 10 of FIG. 5 according to one embodiment of the present invention. Calibrating the sensor 38 may be done to produce the look-up table 32. The look-up table 32 may be used to establish depth characteristics of the tissue surface 24 without the need for separately calculating a depth value for each point of interest 26. The process begins by establishing a range of distance from the tip 20 of the endoscope 12 to the tissue surface 24 and increments of the range of distance “Ds” (step 300). The range of distance “Ds” may be established as 5 to 150 mm, which represents the typical range of distance “Ds” from the tip 20 of the endoscope 12 to the tissue surface 24 of a patient during a medical procedure. The increments of the range of distance “Ds” are established at every 0.1 mm such that the first two values of “Ds” are 5 mm, 5.1 mm and the last two values are 149.9 mm and 150 mm.

The controller 28 causes the movable platform 56 to move, which thereby moves the calibration plate 54, through the range of distance in each of the increments “Ds” (step 302). At each increment “Ds,” the projector/scanner controller 30 directs the projector/scanner 36 to project the point of light 42 onto the calibration plate 54 at each x and y coordinate “Sx,” “Sy” over the range of x and y coordinates of the projector/scanner 36 resulting in a reflected image 44 captured by the sensor 38 (step 304). The projector/scanner controller 30 does this in a row by row process. The projector/scanner controller 30 outputs a “Sy” coordinate to the projector/scanner 36 and then directs the projector/scanner 36 to project the point of light 42 to each “Sx” coordinate in line with the “Sy” coordinate. The position of the region of brightness of the reflected image 44 “Lx,” “Ly” is detected by the sensor 38 and outputted to the controller 28. The projector/scanner controller 30 outputs the next “Sy” coordinate to the projector/scanner 36 and the same process is performed for that “Sy” coordinate. The process continues for each “Sy” coordinate and for each increment “Ds.”

The controller 28 records in the look-up table 32 the values for position of the region of brightness “Lx,” “Ly” for each x, y coordinate “Sx,” “Sy” at each increment “Ds” (step 306). The controller 28 records the values in the look-up table 32 row-by-row as the “Lx,” “Ly” values are received from the sensor 38 until the look-up table 32 is completed. Once the look-up table 32 is completed the calibration process stops.

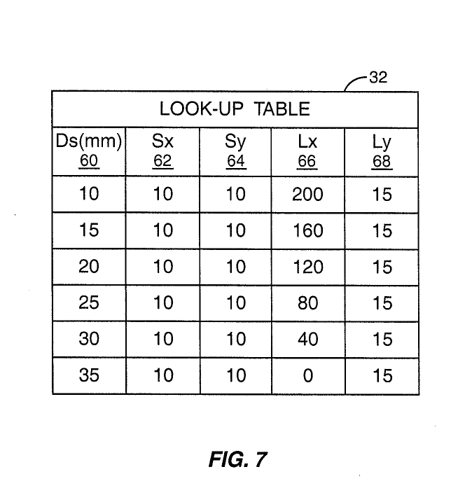

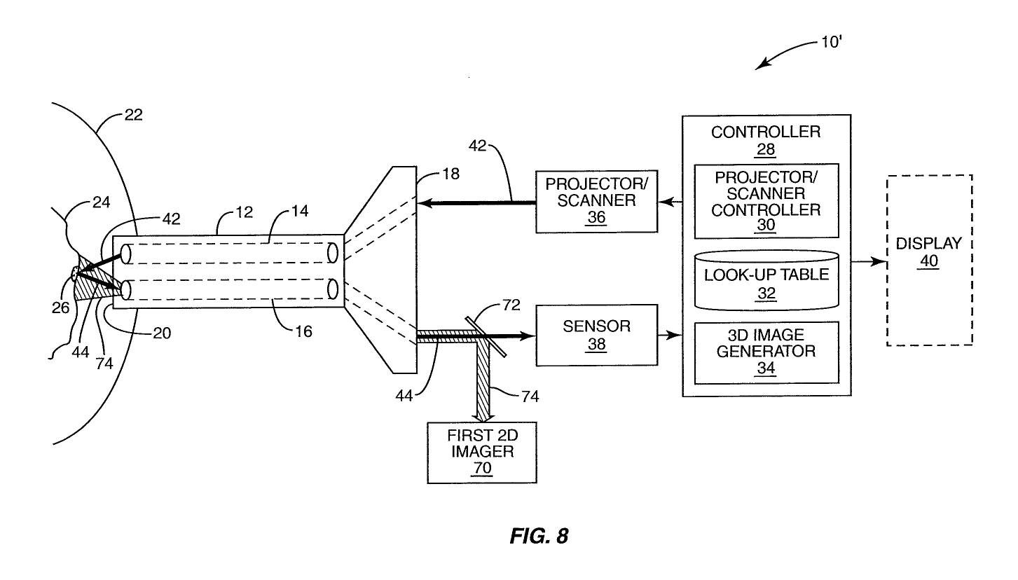

FIG. 7 illustrates a representation of a portion of a completed look-up table 32 according to an embodiment of the present invention to illustrate the manner in which the look-up table 32 may be structured to facilitate the determination of the depth value for the point of interest 26. The look-up table 32 may be structured with multiple columns “Ds” 60, “Sx” 62, “Sy” 64, “Lx” 66, and “Ly” 68. Each row under column “Ds” 60 lists an increment of the range of distance “Ds.” For each “Ds” row the values for “Sx,” “Sy,” “Lx,” and “Ly” are recorded. Each value under column “Ds” 60 represents a depth value. Accordingly, the look-up table 32 may be used to determine depth characteristics of the tissue surface 24 in the system 10 of FIG. 1. For ease of discussing the embodiment of the present invention, the look-up table 32 in FIG. 7 includes values of “Ds” in 5 mm increments.

In operation, the projector/scanner controller 30 directs the projector/scanner 36 to project the point of light 42 in a similar manner to the calibration process described above. The projector/scanner controller 30 directs the projector/scanner 36 to project the point of light 42 onto the tissue surface 24 at each x and y coordinate “Sx,” “Sy” over the range of x and y coordinates of the projector/scanner 36 resulting in a reflected image 44 captured by the sensor 38. The projector/scanner controller 30 outputs a “Sy” coordinate to the projector/scanner 36 and then directs the projector/scanner 36 to project the point of light 42 to a “Sx” coordinate in line with the “Sy” coordinate. The position of the region of brightness of the reflected image 44 “Lx,” “Ly” is detected by the sensor 38 and outputted to the controller 28.

The controller 28 uses the values for “Sx,” “Sy,” “Lx,” and “Ly” as a look-up key in the look-up table 32. The controller 28 finds the closest matching row to the values for “Sx,” “Sy,” “Lx,” and “Ly” and reads the value of “Ds” for that row. The controller 28 then stores the “Ds” value in the depth map as the depth of the point of interest 26 located at the “Sx,” “Sy” coordinate. The controller 28 continues this process for other points of interest 26 on the tissue surface 24 to generate the three-dimensional structured-light depth map.

The 3D image generator 34 generates the three-dimensional image signal from the three-dimensional structured-light depth map. The three-dimensional image from the three-dimensional image signal generated from the three-dimensional structured-light depth map may not have sufficient texture to provide the quality of viewing appropriate for a medical procedure. To address this, two-dimensional image components may be incorporated in the system 10 of FIG. 1.

Accordingly, FIG. 8 is a schematic diagram illustrating system 10′, which may include the depth extraction components in system 10 of FIG. 1 and first two-dimensional image components, according to one embodiment of the present invention. FIG. 8 illustrates the manner in which the system 10 may be expanded by the addition of a high-resolution imager to provide a back-up image source and texture to the three-dimensional image signal.

The system 10′ includes a first two-dimensional imager 70 which may be communicably coupled to the controller 28 and optically coupled to the second channel 16 of the endoscope 12. The first two-dimensional imager 70 may be mounted at angle of 90 degrees from a centerline of the second channel 16. A first filter 72 may be interposed between the first two-dimensional imager 70 and the second channel 16. The first two-dimensional imager 70 may be used to capture a first two-dimensional image 74 of the tissue surface 24 through the second channel 16. Additionally, the first two-dimensional imager 70 may be separately communicably connected to the display 40 to provide a back-up image of the tissue surface 24 if the three-dimensional image signal fails for any reason. Accordingly, the first two-dimensional imager 70 may be always “on” and ready for use.

As discussed above, in the case where the sensor 38 is located at the distal end 18, the sensor 38 may capture the reflected image 44 through the second channel 16. As such, the first two-dimensional image 74 and the reflected image 44 may be conveyed simultaneously through the second channel 16. Accordingly, to effectively process the reflected image 44 and the first two-dimensional image 74, the first two-dimensional image 74 and the reflected, image 44 may have to be separated after being conveyed through the second channel 16.

The first filter 72 may be provided to filter the reflected image 44 from the first two-dimensional image 74 and accomplish the separation. The first filter 72 may be any appropriate narrowband filter such as a chromeric filter, an interference filter, or any combination thereof for example. In this embodiment, the first filter 72 is an interference filter, which filters light based on wavelength. As discussed above, the point of light 42 projected on the tissue surface 24 may be a single color, such as green which has a wavelength of approximately 532 nanometers (nm). Therefore, the reflected image 44 resulting from the point of light 42 may also be a single color of green with a wavelength of 532 nm.

Accordingly, the first filter 72 may be a 568 nm interference filter oriented at a 45 degree angle with respect to the path of conveyance through the second channel 16 of the first two-dimensional image 74. The first filter 72 may allow the reflected image 44, at 532 nm, to pass through unaffected. However, the first filter 72 may not allow the first two-dimensional image 74 to pass through, but may reflect the first two-dimensional image 74. Because the first filter 72 may be oriented at a 45 degree angle, the first filter 72 may reflect the first two-dimensional image 74 90 degrees from its path of conveyance through the second channel 16.

After being reflected by the first filter 72, the first two-dimensional image 74 may align with the first two-dimensional imager 70 which may be mounted at an angle of 90 degrees from the centerline of the second channel 16 as discussed above. The first two-dimensional imager 70 may capture the first two-dimensional image 74 and produce a first two-dimensional image signal. The first two-dimensional image signal may outputted to and received by the controller 28.

The first two-dimensional imager 70 may use the illumination provided by the point of light 42 projected on the tissue surface 24 or, alternatively and/or additionally, may use a separate white light source to illuminate the tissue surface 24. Using the separate white light source may provide additional safety in the event of a failure of the projector/scanner 36 and/or other components of the system 10′. The separate white light source may be the light source commonly used with endoscopes and be mounted on and/or integrated with the endoscope 12. As such, the white light source may be projected through standard fiber bundles normally used with endoscopes or may be a local light source. Optionally, the white light source may also comprise narrow-band filters to remove the light wavelengths of the point of light 42.

The first two-dimensional imager 70 may be any suitable high-speed, high-resolution monochromatic, color, analog, digital, or any combination thereof, camera. Additionally, the first two-dimensional imager has standard definition TV, HD, VGA, and other computer resolutions of any other standard computer, medical, or industrial resolution. An exemplary camera suitable for capturing the first two-dimensional image 74 and providing a first two-dimensional image signal to the controller 28 is the DA-512 available from Dalsa Corporation.

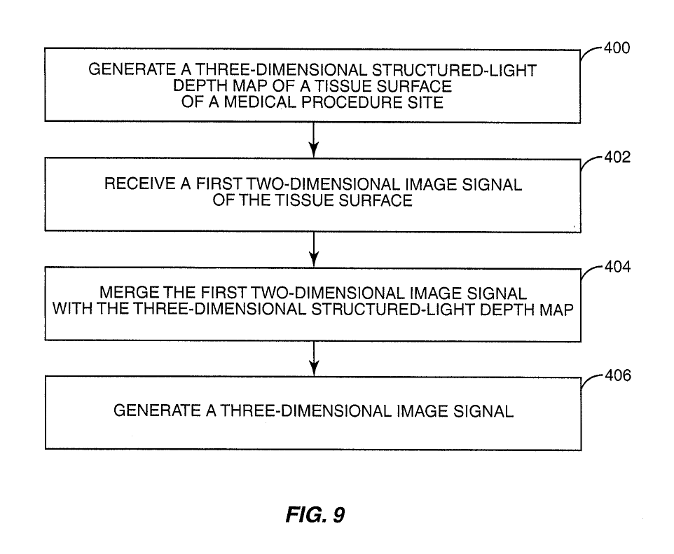

The controller 28 receives the two-dimensional image signal and may use the first two-dimensional image signal to provide texture for the three-dimensional image resulting from the three-dimensional image signal. The controller 28 may merge the first two-dimensional image signal with the three-dimensional image signal by performing a standard texture mapping technique whereby the first two-dimensional image signal is wrapped onto the three-dimensional structured-light depth map. If the first two-dimensional imager 70 is a monochromatic camera, the three-dimensional image resulting from the texture mapping may have a grayscale texture. If the first two-dimensional imager 70 is a color camera, the three-dimensional image resulting from the texture mapping may have a color texture. In either case, the process for merging the first two-dimensional image signal with the three-dimensional structured-light depth map is further detailed with respect to the discussion of FIG. 9.

FIG. 9 is a flow chart illustrating a process for generating the three-dimensional image signal by merging the first two-dimensional image signal with the three-dimensional image signal by wrapping the two-dimensional image signal of the tissue surface 24 onto the three-dimensional structured-light depth map of the tissue surface 24 according to one embodiment of the present invention. The process begins by the controller 28 generating a three-dimensional structured-light depth map of a tissue surface 24 of a medical procedure site 22 (step 400). The three-dimensional structured-light depth map may be generated by the process discussed above with reference to FIG. 2. The controller 28 receives a first two-dimensional image signal of the tissue surface 24 (step 402).

The controller 28 then merges the first two-dimensional image signal with the three-dimensional structured-light depth map (step 404). As discussed above, the controller 28 may merge the two-dimensional image signal with the three-dimensional structured-light depth map by wrapping the first two-dimensional image signal onto the three-dimensional structured-light depth map by texture mapping the first two-dimensional image signal onto the three-dimensional structured-light depth map. Texture mapping involves the mathematical mapping of the texture from one image signal to another to affect the grayscale or color texture, based on whether the two-dimensional imager 70 is monochromatic or color. Accordingly, the texture is achieved through the manipulation of the grayscale or the color and not by affecting any depth values in the three-dimensional structured-light depth map.

The controller 28 then generates a three-dimensional image signal from the first two-dimensional image signal and the three-dimensional structured-light depth map (step 406). The controller 28 may then send the three-dimensional image signal to the display 40 for viewing a three-dimensional image that has sufficient texture to provide the quality of image appropriate for the medical procedure.

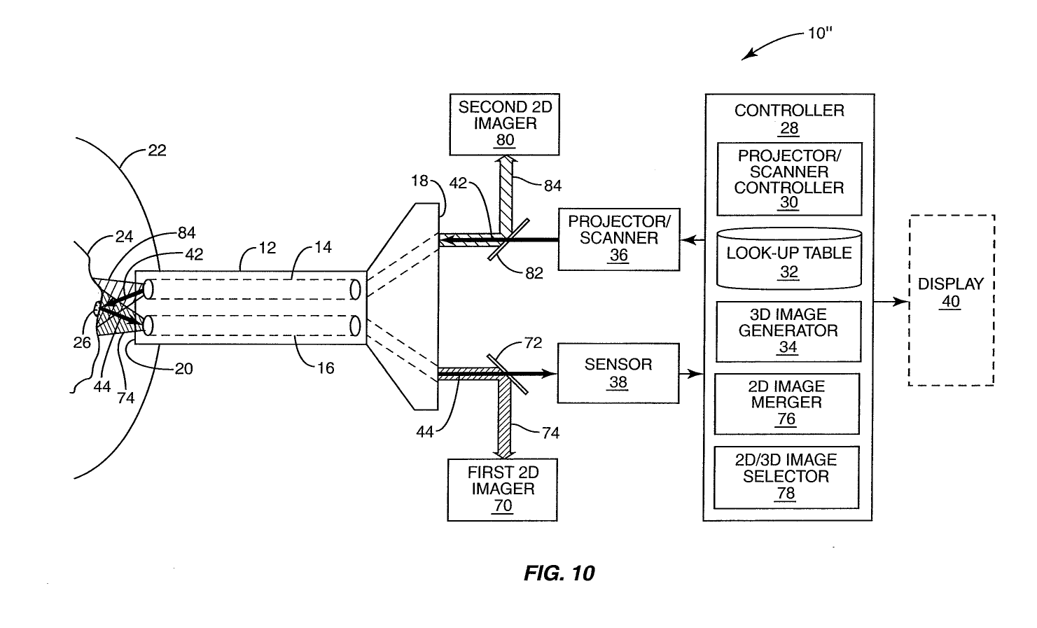

Even with the three-dimensional image having sufficient texture to provide a high quality image, there may be a need for providing a separate two-dimensional stereo image for viewing during a medical procedure. Accordingly, a system that generates a two-dimensional stereo image signal of the tissue surface 24 in addition to a three-dimensional image signal of the tissue surface 24 may be desirable. FIG. 10 is a schematic diagram of an exemplary system 10″, which includes depth extraction components for generating the three-dimensional image signal, and first and second two-dimensional imagery components for generating the two-dimensional stereo image signal according to one embodiment of the present invention.

FIG. 10 includes the components in system 10 of FIG. 1 and the components in system 10′ of FIG. 8, which will not be described with respect to FIG. 10 except as necessary with respect to any differences or additional functions to fully describe the system 10″. FIG. 10 illustrates the manner in which the system 10 may be further expanded to include another high-resolution imager in addition to the one added in system 10′ of FIG. 8.

The system 10″ includes a second two-dimensional imager 80. The second two-dimensional imager 80 may be communicably coupled to the controller 28 and optically coupled to the first channel 14 of the endoscope 12. The second two-dimensional imager 80 may be mounted at angle of 90 degrees from a centerline of the first channel 14. A second filter 82 may be interposed between the second two-dimensional imager 80 and the first channel 14. The second two-dimensional imager 80 may be used to capture a second two-dimensional image 84 of the tissue surface 24 through the first channel 14. Additionally, similarly to the first two-dimensional imager 70, the second two-dimensional imager 80 may be separately communicably connected to the display 40 to provide a back-up image of the tissue surface 24 if the three-dimensional image signal fails for any reason. Accordingly, the second two-dimensional imager 80 may also be always “on” and ready for use.

As discussed above, in the case where the projector/scanner 36 is located at the distal end 18, the projector/scanner 36 may project the point of light 42 through the first channel 14. As such, the second two-dimensional image 84 and the point of light 42 may be conveyed simultaneously through the first channel 14, albeit in opposite directions. Accordingly, to effectively process the second two-dimensional image 84, the second two-dimensional image 84 may have to be separated from the point of light 42 after the second two-dimensional image 84 is conveyed through the first channel 14.

The second filter 82 may be provided to filter the reflected image 44 from the first two-dimensional image 74 and accomplish the separation. The second filter 82 may be any appropriate narrowband filter such as a chromeric filter, an interference filter, or combinations thereof for example. In this embodiment, the second filter 82 is an interference filter, which filters light based on wavelength. The present invention is not limited to any specific type of filter.

As discussed above, the point of light 42 projected on the tissue surface 24 may be a single color, such as green, which has a wavelength of approximately 532 nm. Accordingly, the second filter 82 may be a 568 nm interference filter oriented at a 45 degree angle with respect to the path of conveyance through the first channel 14 of the second two-dimensional image 84. The second filter 82 may allow the point of light 42, at 532 nm, to pass through unaffected. However, the second filter 82 may not allow the second two-dimensional image 84 to pass through, but may reflect the second two-dimensional image 84. Because the second filter 82 may be oriented at a 45 degree angle, the second filter 82 may reflect the second two-dimensional image 84 90 degrees from its path of conveyance through the first channel 14.

After being reflected by the second filter 82, the second two-dimensional image 84 may align with the second two-dimensional imager 80 which may be mounted at an angle of 90 degrees from the centerline of the first channel 14 as discussed above. The second two-dimensional imager 80 may capture the second two-dimensional image 84 and produce a second two-dimensional image signal. The second two-dimensional image signal may output to and be received by the controller 28.

Similarly to the first two-dimensional imager 70, the second two-dimensional imager 80 may use the illumination provided by the point of light 42 projected on the tissue surface 24, or, alternatively and/or additionally, may use a separate white light source to illuminate the tissue surface 24. Also, using the separate white light source may provide additional safety in the event of a failure of the projector/scanner 36 and/or other components of the system 10″. The separate white light source may be the light source commonly used with endoscopes and may be mounted on and/or integrated with the endoscope 12. As such, the white light source may be projected through standard fiber bundles normally used with endoscopes or may be a local light source. Optionally, the white light source may also comprise narrow-band filters to remove the light wavelengths of the point of light 42.

Additionally, as with the first two-dimensional imager 70, the second two-dimensional imager 80 may be any suitable high-speed, high-resolution monochromatic, color, analog, digital, or any combination thereof, camera. Additionally, the second two-dimensional imager 80 may have standard definition TV, HD, VGA, and other computer resolutions of any other standard computer, medical, or industrial resolution. An exemplary camera suitable for capturing the first two-dimensional image 84 and providing a first two-dimensional image signal to the controller 28 is the DA-512 available from Dalsa Corporation.

The controller 28 may receive the second two-dimensional image signal from the second two-dimensional imager 84. The 2D image merger 76 in the controller 28 may merge the first two-dimensional image signal with the second two-dimensional image signal to generate a two-dimensional stereo image signal. The 2D image merger 76 may be any program, algorithm, or control mechanism for merging the first two-dimensional image signal and the second two-dimensional image signal. Merging the second two-dimensional image signal with the first two-dimensional image signal to generate the two-dimensional stereo image signal may be performed in the standard manner well known in the art.

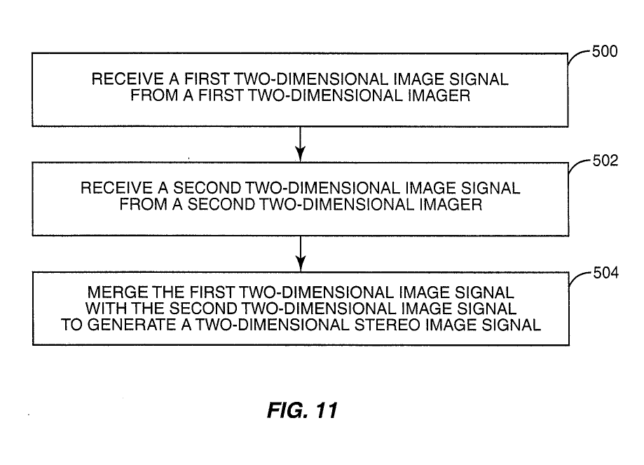

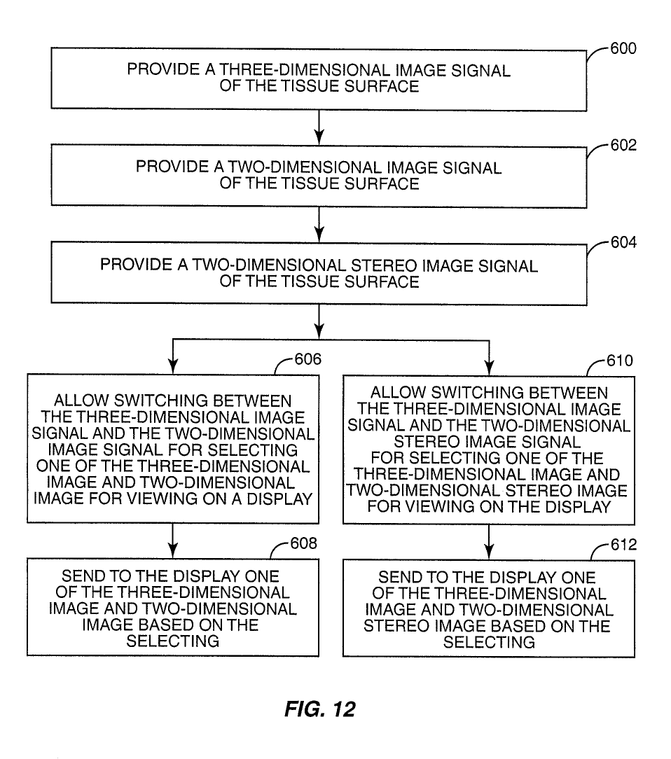

FIG. 11 is a flow chart illustrating the process for generating the two-dimensional stereo image signal according to one embodiment of the present invention. The controller 28 receives a first two-dimensional image from a first two-dimensional imager 70 (step 500). The controller 28 also receives a second two-dimensional image from a second two-dimensional imager 80 (step 502). The controller 28 merges the first two-dimensional image signal with the second two-dimensional image signal to generate a two-dimensional stereo image signal (step 504). The controller 28 may then send the two-dimensional stereo image signal to the display 40 for viewing the two-dimensional stereo image of the tissue surface 24.

Accordingly, the system 10″ of FIG. 10 may generate the three-dimensional image signal using the depth extraction components in the system 10 of FIG. 1, separately and/or merged with the first two-dimensional image signal generated using the first two-dimensional image components in system 10′ of FIG. 8, and may generate the two-dimensional stereo image signal. The three-dimensional image signal, one of the first two-dimensional image signal and the second two-dimensional image signal, and the two-dimensional stereo image signal may alternately be sent to the display 40 for viewing. For ease of explaining the embodiment of the present invention hereafter, the terms two-dimensional image signal and two-dimensional image shall be used. It should be understood that two-dimensional image signal refers to either one of the first two-dimensional image signal and the second two-dimensional image signal. Similarly, two-dimensional image shall mean a two-dimensional image from either one of the first two-dimensional image signal and the second two-dimensional image signal. Accordingly, the use of two-dimensional image signal and/or two-dimensional image shall be understood not to be construed as selecting or limiting either one of the first two-dimensional image signal and the second two-dimensional image signal in any manner.

One of the three-dimensional image, the two-dimensional image, and the two-dimensional stereo image may be selected for viewing during the medical procedure. Selecting one of the three-dimensional image, the two-dimensional image, and the two-dimensional stereo image may be accomplished by allowing switching between the three-dimensional image signal, the two-dimensional image signal, and the two-dimensional stereo image signal. The controller 28 includes a 2D/3D image selector 78 to provide the capability to allow for such switching. The 2D/3D image selector 78 may be any program, algorithm, or control mechanism to allow switching between the three-dimensional image signal, the two-dimensional image signal, and the two-dimensional stereo image signal.

FIG. 12 is a flow chart that illustrates the process for switching between the three-dimensional image signal, the two-dimensional image signal, and the two-dimensional stereo image signal. The controller 28 provides the three-dimensional image signal of the tissue surface 24 (step 600). The three-dimensional image signal may be generated from a three-dimensional structured-light depth map as described with reference to the system 10 of FIG. 1 or in some other manner. The controller 28 provides a two-dimensional image signal of the tissue surface 24 (step 602). The two-dimensional image signal may one of the first two-dimensional image signal and the second two-dimensional image signal. The controller 28 provides a two-dimensional stereo image signal of the tissue surface 24 (step 604). The two-dimensional stereo image signal may be generated by merging the first two-dimensional image signal and the second two-dimensional image signal as described above. The controller 28 allows switching between the three-dimensional image signal and the two-dimensional image signal for selecting one of the three-dimensional image and the two-dimensional image for viewing on the display 40 (step 606). The controller 28 then sends one of the three-dimensional image signal and the two-dimensional image signal to the display 40 based on the selecting (step 608). Similarly, the controller 28 allows switching between the three-dimensional image signal and the two-dimensional stereo image signal for selecting one of the three-dimensional image and the two-dimensional stereo image for viewing on the display 40 (step 610). The controller 28 then sends one of the three-dimensional image signal and the two-dimensional stereo image signal to the display 40 based on the selecting (step 612).

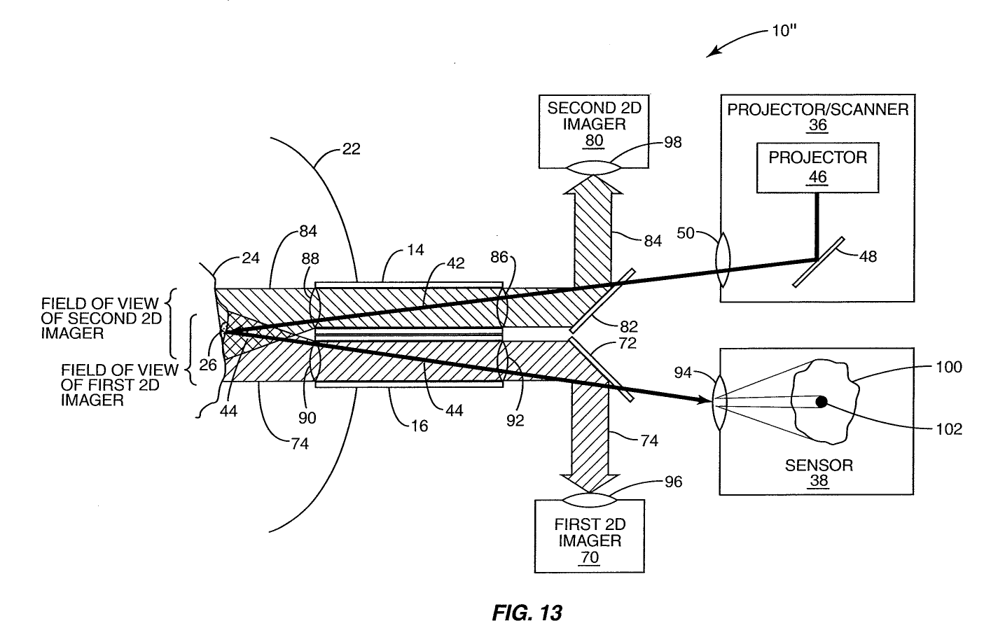

FIG. 13 is an optical schematic diagram of the system 10″and is provided to further discuss the optical components of the system 10″ and their interaction. In particular, FIG. 13 includes additional detail of the components showing exemplary lenses that may be included in the system 10. The description of the components and their function previously discussed with respect to other figures will not be repeated with respect FIG. 13.

As discussed above, the projector 46 may be a laser and may remain relatively stationary during operation. The scanner 48 may provide the appropriate movement for aiming the point of light 42 at the point of interest 26. In effect, the scanner 48 scans the point of light 42 onto the points of interest 26 on the tissue surface 24 based on an x-y coordinate pattern. Although discussed above, the scanning pattern may be in a raster pattern; alternatively, the pattern may take different forms such as circular, pseudo-random, and addressable scan. While a laser beam may be reduced to provide the appropriate size of approximately 0.4 mm, the point of light 42 retains collimation through the system 10″. The point of light 42 is projected through the projection lens 50, the second filter 82, a first channel distal lens 86, the first channel 14, and a first channel proximal lens 88 onto the point of interest 26 on the tissue surface 24. The projection lens 50, although shown as one lens, may comprise multiple lenses, and may be used for focusing, expansion, and contraction of the point-of-light 42. As discussed above, the second filter 82 is a narrowband filter that allows the point of light 42 to pass through unaffected.

The projection of the point-of-light 42 on the point of interest 26 results in a reflected image 44. The reflected image 44 may be captured through a second channel proximal lens 90, the second channel 16, a second channel distal lens 92, the first filter 72, and a sensor lens 94. The first filter 72 may allow the reflected image 44 to pass through unaffected. The sensor lens 94 may focus and/or adjust the reflected image 44 to more closely match the reflected image 44 size to the point of light 42 as projected by the projector/scanner 36. The sensor 38 may not create a full raster image of the point of interest 26, but may capture the entire field 100 and locate a position of the region of brightness 102 of the resulting image 44. Because the point of light 42 may be very small, the position of region of brightness 102 may be of high intensity and at or very near the centroid of the reflected image 44. Additionally, contrast may remain high as only a very narrow band of approximately 532 nm may be used and, therefore, may overwhelm any stray light at that wavelength.

The first two-dimensional image 74 of the tissue surface 24 may be captured through the second channel proximal lens 90, the second channel 16, and the second channel distal lens 92. The first filter 72 may reflect the first two-dimensional image 74 such that the first two-dimensional image 74 may align with and pass through a first two-dimensional imager lens 96 on the first two-dimensional imager 70. The second channel proximal lens 90 and the second channel distal lens 92 may act to refocus the first two-dimensional image 74, for example for infinity correction, compressing the beam, and/or making other optical adjustments. The first two-dimensional imager lens 96 may provide additional focusing, beam shaping, image size adjustment, color correction, and other functions prior to the first two-dimensional imager 70 capturing the first two-dimensional image 74.

Similarly, the second two-dimensional image 84 of the tissue surface 24 may be captured through the first channel proximal lens 88, the second channel 16, and the second channel distal lens 92. The second filter 82 may reflect the second two-dimensional image 84 such that the second two-dimensional image 84 may align with and pass through a second two-dimensional imager lens 98 on the second two-dimensional imager 80. The first channel proximal lens 88 and the first channel distal lens 86 may act to refocus the second two-dimensional image 84, for example for infinity correction, compressing the beam, and/or making other optical adjustments. The second two-dimensional imager lens 98 may provide additional focusing, beam shaping, image size adjustment, color correction, and other functions prior to the second two-dimensional imager 80 capturing the second two-dimensional image 84.

The first two-dimensional imager 70 and the second two-dimensional imager 80 may receive full color imagery with the exception of a very narrow band of light based on the wavelength of the point of light 42. This may be relevant because, as discussed above, both the point of light 42 and the second two-dimensional image 84 pass through the first channel 14. Additionally, the second two-dimensional image 84 may be reflected by the second filter 82. Further, both the reflected image 44 and the first two-dimensional image 74 pass through the second channel 16. Additionally, the first two-dimensional image 74 may be reflected by the first filter 72.

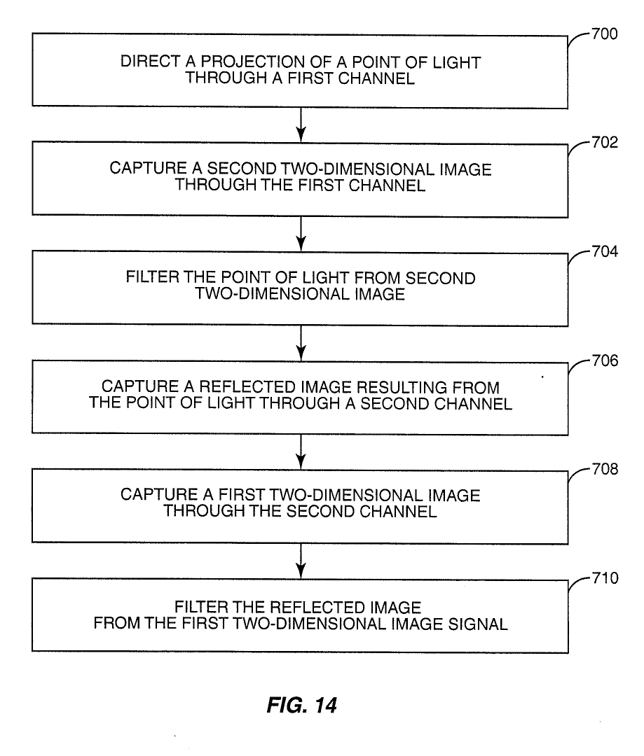

FIG. 14 is a flow chart that illustrates the process for filtering the point of light 42 from the second two-dimensional image 84 and the reflected image 44 from the first two-dimensional image 74. The process begins with directing a projection of the point of light 42 through the first channel 14 (step 700); capturing the second two-dimensional image 84 through the first channel 14 (step 702); filtering the point of light 42 from the second two-dimensional image 84 (step 704); capturing the reflected image 44 resulting from the point of light 42 through the second channel 16 (step 706); capturing the first two-dimensional image 70 through the second channel 16 (step 708); and filtering the reflected image 44 from the first two-dimensional image 74 (step 710).

Referring again to FIG. 10, the 2D image merger 76 in the controller 28 may be adapted to provide depth extraction using a two-dimensional stereo-correspondence technique to generate a two-dimensional stereo-correspondence depth map. Depth extraction using the stereo-correspondence technique may be beneficial for surfaces that are rich in features with sharp edges. While depth extraction using the stereo-correspondence technique may be appropriate for surfaces and objects rich in features with sharp edges, structured-light depth mapping using a structured-light technique may be more appropriate for surfaces and/or objects that are smooth or curved. Accordingly, generating a hybrid three-dimensional image signal using both the stereo-correspondence technique and the structured-light technique may optimally improve the visualization of a surface notwithstanding the actual topology of the surface or object being viewed according to one embodiment of the present invention.

In the system 10″ of FIG. 10, the controller 28 receives the first two-dimensional image signal from the first two-dimensional imager 70 and the second two-dimensional image signal from the second two-dimensional imager 80. Because the first two-dimensional image and the second two dimensional image 84 are a fixed distance apart, due to the spacing of the first channel 14 and the second channel 16, the 2D image merger 76 may use standard computer graphics techniques to locate the same features of the tissue surface 24 in each of the first two-dimensional image 74 and the second two-dimensional image 84. The 2D image merger 76 then may determine any disparity in a pixel location of the same feature in the first two-dimensional image 74 and the second two-dimensional image 84. The 2D image merger 76 may then map the pixel disparities and generate the three-dimensional stereo-correspondence depth map.

As discussed with respect to system 10, system 10′, and system 10″, the structured-light technique comprises projecting a point of light 42 onto a tissue surface 24. For purposes of the embodiment of the present invention though, it should be understood that any pattern of light projected on a surface may be used such as stripes, checkerboards, or crosshairs, for example. The sensor 38 may then detect deformations in the reflected image 44 resulting from the projection of the pattern of light onto the surface, which may be any surface including, but not limited to, the tissue surface 24.

The sensor 38 may send information representative of the deformations in the reflected image 44 to the controller 28. From the information representative of the deformations in the reflected image 44, the 3D image generator 34 in the controller 28 may use the structured-light technique to generate the three-dimensional structured-light depth map. The three-dimensional structured-light depth map and the three-dimensional stereo-correspondence depth map may then be merged in a fashion to generate the hybrid three-dimensional image signal of the surface. In such a case, the determination as to whether to use the three-dimensional structured-light depth map or the three-dimensional stereo-correspondence depth map may be made on a per pixel basis.

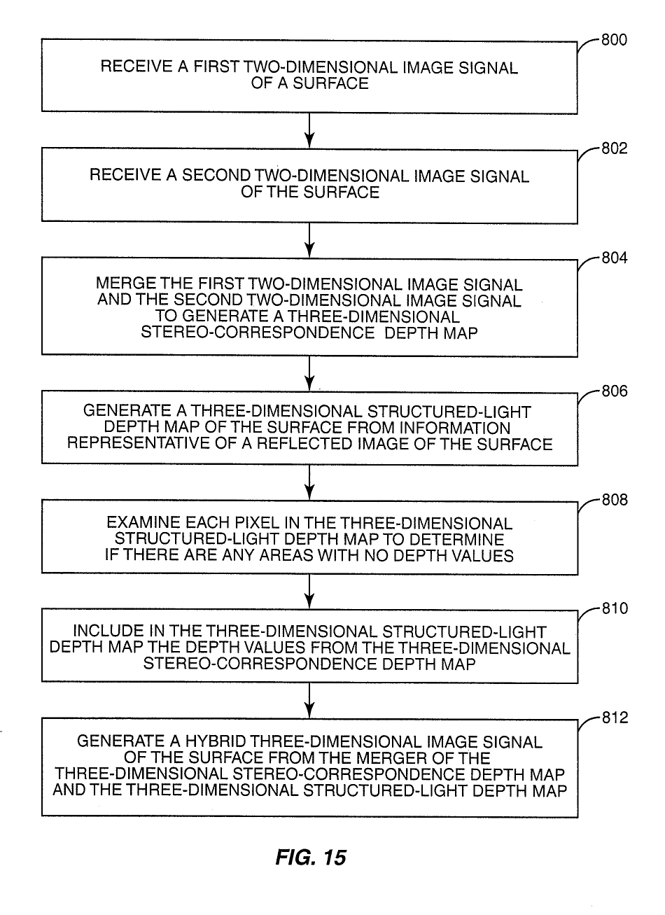

One of the ways in which this may be accomplished is illustrated in FIG. 15. FIG. 15 is a flow chart illustrating a process for generating the hybrid three-dimensional image signal using the stereo-correspondence technique and the structured-light technique according to one embodiment of the present invention.

The controller 28 receives a first two-dimensional image signal of a surface (step 800) and a second two-dimensional image signal of the surface (step 802). The controller 28 merges the first two-dimensional image signal of the surface and the second two-dimensional image signal of the surface and generates a three-dimensional stereo-correspondence depth map (step 804). The controller 28 generates a three-dimensional structured-light depth map of the surface based on information representative of a reflected image 44 of the surface from a projection of a pattern of light onto the surface (step 806). The controller 28 examines each pixel in the three-dimensional structured-light depth map image to determine if there are any areas with no depth values (step 808). Areas where there are no depth values, which also may be referred to as “holes,” may result from the algorithm used in the structured-light technique not being able to compute depth values due to the information representative of the reflected image 44 not seeing or recognizing a projected feature on the surface. The controller 28 includes in the three-dimensional structured-light depth map the depth values from the three-dimensional stereo-correspondence depth map for those areas that do not have depth values (step 810). The controller 28 then generates a hybrid three-dimensional image signal from the merger of the three-dimensional stereo-correspondence depth map and the three-dimensional structured-light depth map (step 812).

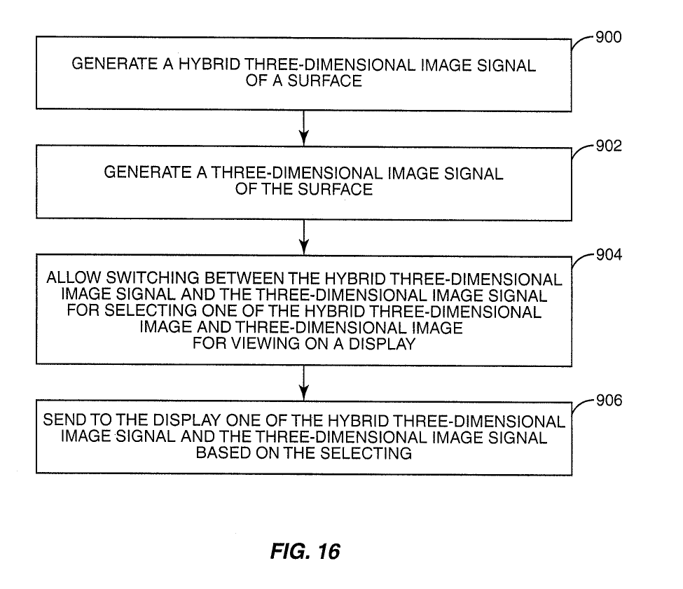

Additionally, a three-dimensional image signal may be generated from the three-dimensional structured-light depth map in addition to merging the three-dimensional structured-light depth map with the three-dimensional stereo-correspondence depth map to generate the hybrid three-dimensional image signal. In such a case, the three-dimensional image signal and the hybrid three-dimensional image signal may alternately be selected and sent to the display 40 for viewing. Accordingly, FIG. 16 illustrates a process for allowing switching between the three-dimensional image signal and the hybrid three-dimensional image signal.

The controller 28 generates the hybrid three-dimensional image signal (step 900). The controller 28 also generates the three-dimensional image signal (step 902). The controller 28 allows switching between the hybrid three-dimensional image signal and the three-dimensional image signal for selecting one of the hybrid three-dimensional image and the three-dimensional image for viewing on the display 40 (step 904). The controller 28 then sends to the display 40 one of the hybrid three-dimensional image signal and the three-dimensional image signal based on the selecting (step 906).

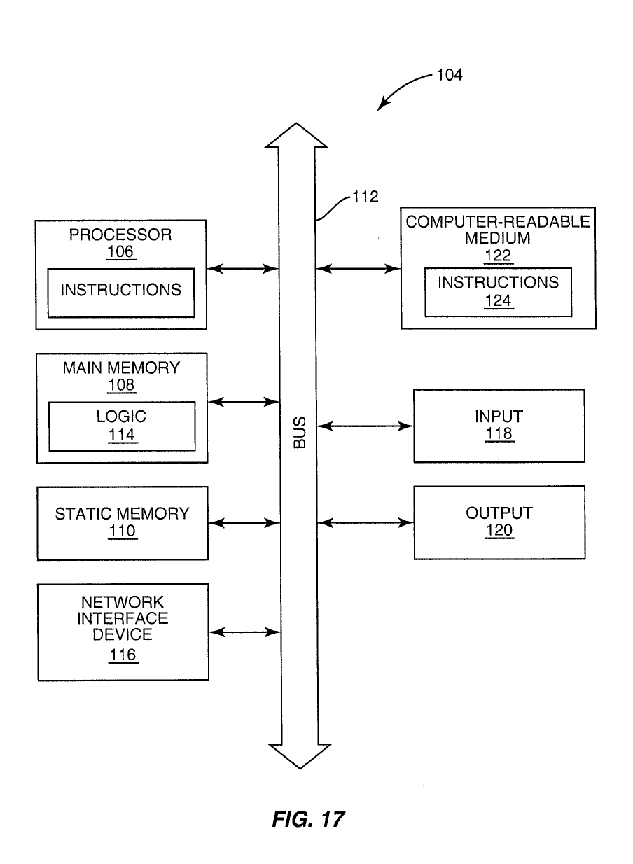

FIG. 17 illustrates a diagrammatic representation of what a controller adapted to execute functioning and/or processing described herein. In the exemplary form, the controller may comprise a computer system 104, within which a set of instructions for causing the controller to perform any one or more of the methodologies discussed herein. The controller may be connected (e.g., networked) to other controllers or devices in a LAN, an intranet, an extranet, or the Internet. The controller may operate in a client-server network environment, or as a peer controller in a peer-to-peer (or distributed) network environment. While only a single controller is illustrated, the term “controller” shall also be taken to include any collection of controllers and/or devices that individually or jointly execute a set (or multiple sets) of instructions to perform any one or more of the methodologies discussed herein. The controller may be a server, a personal computer, a mobile device, or any other device.

The exemplary computer system 104 includes a processor 106, a main memory 108 (e.g., read-only memory (ROM), flash memory, dynamic random access memory (DRAM) such as synchronous DRAM (SDRAM) or Rambus DRAM (RDRAM), etc.), and a static memory 110 (e.g., flash memory, static random access memory (SRAM), etc.), which may communicate with each other via a bus 112. Alternatively, the processor 106 may be connected to memory 108 and/or 110 directly or via some other connectivity means.

The processor 106 represents one or more general-purpose processing devices such as a microprocessor, central processing unit, or the like. More particularly, the processing device may be complex instruction set computing (CISC) microprocessor, reduced instruction set computing (RISC) microprocessor, very long instruction word (VLIW) microprocessor, or processor implementing other instruction sets, or processors implementing a combination of instruction sets. The processor 106 is configured to execute processing logic 114 for performing the operations and steps discussed herein.

The computer system 104 may further include a network interface device 116. It also may include an input means 118 to receive input (e.g., the first two-dimensional imaging signal, the second two-dimensional imaging signal, and information from the sensor 38) and selections to be communicated to the processor 106 when executing instructions. It also may include an output means 120, including but not limited to the display 40 (e.g., a head-mounted display, a liquid crystal display (LCD), or a cathode ray tube (CRT)), an alphanumeric input device (e.g., a keyboard), and/or a cursor control device (e.g., a mouse).

The computer system 104 may or may not include a data storage device having a controller-accessible storage medium 122 on which is stored one or more sets of instructions 124 (e.g., software) embodying any one or more of the methodologies or functions described herein. The instructions 124 may also reside, completely or at least partially, within the main memory 108 and/or within the processor 106 during execution thereof by the computer system 104, the main memory 108, and the processor 106 also constituting controller-accessible storage media. The instructions 124 may further be transmitted or received over a network via the network interface device 116.

While the controller-accessible storage medium 122 is shown in an exemplary embodiment to be a single medium, the term “controller-accessible storage medium” should be taken to include a single medium or multiple media (e.g., a centralized or distributed database, and/or associated caches and servers) that store the one or more sets of instructions. The term “controller-accessible storage medium” shall also be taken to include any medium that is capable of storing, encoding or carrying a set of instructions for execution by the controller and that cause the controller to perform any one or more of the methodologies of the present invention. The term “controller-accessible storage medium” shall accordingly be taken to include, but not be limited to, solid-state memories, optical and magnetic media, and carrier wave signals.

Those skilled in the art will recognize improvements and modifications to the preferred embodiments of the present invention. All such improvements and modifications are considered within the scope of the concepts disclosed herein and the claims that follow.

What is claimed is:

1. A method of providing three-dimensional imagery of a surface, comprising:
receiving a first two-dimensional image of the surface, said first two-dimensional image being from a first two-dimensional imager;
receiving a second two-dimensional image of the surface, said second two-dimensional image being from a second two-dimensional imager;
receiving reflective light data related to the surface, said reflective light data being generated by a sensor receiving reflected light being sent from a light source;
generating, using one or more processors, a three-dimensional stereo-correspondence depth map based on the first two-dimensional image and the second two dimensional image;
generating, using one or more processors, a three-dimensional structured-light depth map of the surface based on the light data received from the sensor, said light being a reflection of projected light off the surface; and
generating, using one or more processors, a three-dimensional model of the surface based on the three-dimensional stereo-correspondence depth map and the three-dimensional structured-light depth map.

2. The method of claim 1, wherein the method further comprises rendering the generated three-dimensional model of the surface.

3. The method of claim 1, wherein the method further comprises:
causing a projection of a point of light onto the surface at a medical procedure site resulting in light reflecting off the surface;
determining depth characteristics of the surface based on brightness detected by the sensor, said sensor being other than a two-dimensional array imager; and
wherein generating a three-dimensional structured-light depth map comprises generating a three-dimensional structured-light depth map of the surface from the depth characteristics.

4. The method of claim 3, wherein causing a projection of a point of light comprises directing the projection of the point of light through a first channel of an endoscope.

5. The method of claim 1, wherein generating the three-dimensional model of the surface comprises generating a hybrid three-dimensional image by merging the three-dimension stereo-correspondence depth map and the three-dimensional structured-light depth map.

6. The method of claim 1, wherein generating the three-dimensional model of the surface comprises choosing between the three-dimensional stereo-correspondence depth map and the three-dimensional structured-light depth map.

7. The method of claim 1, wherein the surface is a surface at a medical procedure site.

8. A system for providing three-dimensional imagery of a surface, comprising one or more processors, said one or more processors being configured to:
receive a first two-dimensional image of the surface, said first two-dimensional image being from a first two-dimensional imager;
receive a second two-dimensional image of the surface, said second two-dimensional image being from a second two-dimensional imager;
receive reflective light data related to the surface, said reflective light data being generated by a sensor receiving reflected light being sent from a light source;
generate a three-dimensional stereo-correspondence depth map based on the first two-dimensional image and the second two dimensional image;
generate a three-dimensional structured-light depth map of the surface based on the light data received from the sensor, said light being a reflection of projected light off the surface; and
generate a three-dimensional model of the surface based on the three-dimensional stereo-correspondence depth map and the three-dimensional structured-light depth map.

9. The system of claim 8, wherein the system is further configured to render the generated three-dimensional model of the surface.

10. The system of claim 8, the system being further configured to:
cause a projection of a point of light onto the surface at a medical procedure site resulting in light reflecting off the surface;
determining depth characteristics of the surface based on brightness detected by the sensor, said sensor being other than a two-dimensional array imager; and
wherein generating a three-dimensional structured-light depth map comprises generating a three-dimensional structured-light depth map of the surface from the depth characteristics.

11. The system of claim 10, wherein causing a projection of a point of light comprises directing the projection of the point of light through a first channel of an endoscope.

12. The system of claim 10, wherein the sensor comprises a lateral effect photodiode (LEPD).

13. The system of claim 8, wherein generating three-dimensional model of the surface comprises generating a hybrid three-dimensional image by merging the three-dimensional stereo-correspondence depth map and the three-dimensional structured-light depth map.

14. The system of claim 8, wherein generating the three-dimensional model of the surface comprises choosing between the three-dimensional stereo-correspondence depth map and the three-dimensional structured-light depth map.

15. A non-transient computer-readable medium, said non-transient computer-readable media having computing instructions thereon, said computing instructions, when executed by one or more processors, causing the one or more processors to perform the following method:
receiving a first two-dimensional image of the surface, said first two-dimensional image being from a first two-dimensional imager;
receiving a second two-dimensional image of the surface, said second two-dimensional image being from a second two-dimensional imager;
receiving reflective light data related to the surface, said reflective light data being generated by a sensor receiving reflected light being sent from a light source;
generating, using one or more processors, a three-dimensional stereo-correspondence depth map based on the first two-dimensional image and the second two dimensional image;
generating, using one or more processors, a three-dimensional structured-light depth map of the surface based on the light data received from the sensor, said light being a reflection of projected light off the surface; and
generating, using one or more processors, a three-dimensional model of the surface based on the three-dimensional stereo-correspondence depth map and the three-dimensional structured-light depth map.

16. The computer-readable medium of claim 15, wherein the method further comprises rendering the generated three-dimensional model of the surface.

17. The computer-readable medium of claim 15, wherein the method further comprises:
causing a projection of a point of light onto the surface at a medical procedure site resulting in light reflecting off the surface;
determining depth characteristics of the surface based on brightness detected by the sensor, said sensor being other than a two-dimensional array imager; and
wherein generating a three-dimensional structured-light depth map comprises generating a three-dimensional structured-light depth map of the surface from the depth characteristics.

18. The computer-readable medium of claim 17, wherein causing a projection of a point of light comprises directing the projection of the point of light through a first channel of the endoscope.

19. The computer-readable media of claim 15, wherein generating the three-dimensional model of the surface comprises generating a hybrid three-dimensional image by merging the three-dimensional stereo-correspondence depth map and the three-dimensional structured-light depth map.

20. The computer-readable media of claim 15, wherein generating the three-dimensional model of the surface comprises choosing between the three-dimensional stereo-correspondence depth map and the three-dimensional structured-light depth map.
